(19) United States
(12) Patent Application Publication
(10) Pub. No.: US 2006/0173736 A1
(43) Pub. Date: Aug. 3, 2006

(54) System and method for providing purchasing incentives over a network

(76) Inventors: Brandi Jo Huyser, Caledonia, MI (US); Kent Dickinson, Byron Center, MI (US)

Correspondence Address: IN RE: ALTICOR INC. 28533;BRINKS, HOFER, GILSON & LIONE, P.O. BOX 10395, CHICAGO, IL, 60610, US

(21) Appl. No.: 11/047,911

(22) Filed: Jan. 31, 2005

(51) Int. Cl. G06Q 30/00

(52) U.S. Cl. 705/14

(57) ABSTRACT

A method and system for providing an incentive to purchase merchandise from a merchant over a computer network is disclosed. A merchant computer is coupled to a customer computer through a computer network. The merchant computer has a memory area that is searchable for determining a first merchandise available for purchase. Further, an executable program code is provided that is stored in the memory area of the merchant computer for creating an incentive program to facilitate the purchase of a second merchandise by the customer from the merchant. The incentive program facilitates the purchase of the second merchandise by issuing incentive program credits that may be redeemed toward the purchase of the second merchandise. The executable program code further includes program code for determining the customer price of the second merchandise, the expense incurred by the merchant to obtain the second merchandise and the maximum incentive program credits that the customer may redeem toward the purchase of the second merchandise. The maximum incentive program credits that the customer may redeem toward the purchase of the second merchandise are calculated by subtracting the expense incurred by the merchant to obtain the second merchandise from the customer price of the second merchandise.

### TECHNICAL FIELD

The present invention generally relates to systems and methods for providing an incentive to purchase a product from a merchant.

### BACKGROUND

Many merchants today have established incentive programs to increase retail sales of their merchandise. These programs range from straight merchandise discounts where the merchant has reduced the retail customer price of the goods by a certain percentage to programs where consumers earn points that can be redeemed to purchase other products from that merchant. For example, credit card companies may pay credit card users a percentage of the total amount charged by the credit card holders, this sum being then credited to a users account, such as to be used to reduce the credit cardholders' debt or made available to the user to make additional purchases. Other merchants have established an incentive program, such as a frequent buyer program, where customers earn tickets, punches or points for purchases made at participating stores. For example, Subway restaurants maintains an incentive program where customers earn tickets which may be accumulated and redeemed toward the purchase of a currently available item, such as a sandwich or drink. More specifically, in the case of the Subway incentive program a customer must accumulate approximately seven tickets before the tickets may be redeemed to purchase a Subway sandwich.

While these incentives systems and programs work for their intended purpose, many improvements may be made. Incentive programs are an expense that reduce the merchandisers' profits and therefore must be controlled in order to prevent losses. Moreover, a merchant might want to exclude certain items that may be purchased through redemption of the consumer's credits because it would be impractical to offer those items for redemption.

Therefore a need exists for a new and improved system and method for providing an incentive to purchase products from a merchandiser. The new and improved system should provide a means for safeguarding against incurring high costs to administer the program. Further the new and improved system and method should provide a customer of a merchandiser the opportunity to purchase goods the customer wishes to purchase at a discount.

### BRIEF DESCRIPTION OF THE DRAWINGS

FIG. 1 is schematic diagram of a system for conducting the incentive program over a computer network, in accordance with an embodiment of the present invention;

FIG. 2 is a flow chart illustrating a method for providing an incentive to purchase products from a merchandiser, in accordance with an embodiment of the present invention; and

FIG. 3 is a flow chart illustrating a method for determining the customer price and the maximum number of credits that may be used by a customer to redeem toward the purchase of an item, in accordance with an embodiment of the present invention.

### DETAILED DESCRIPTION

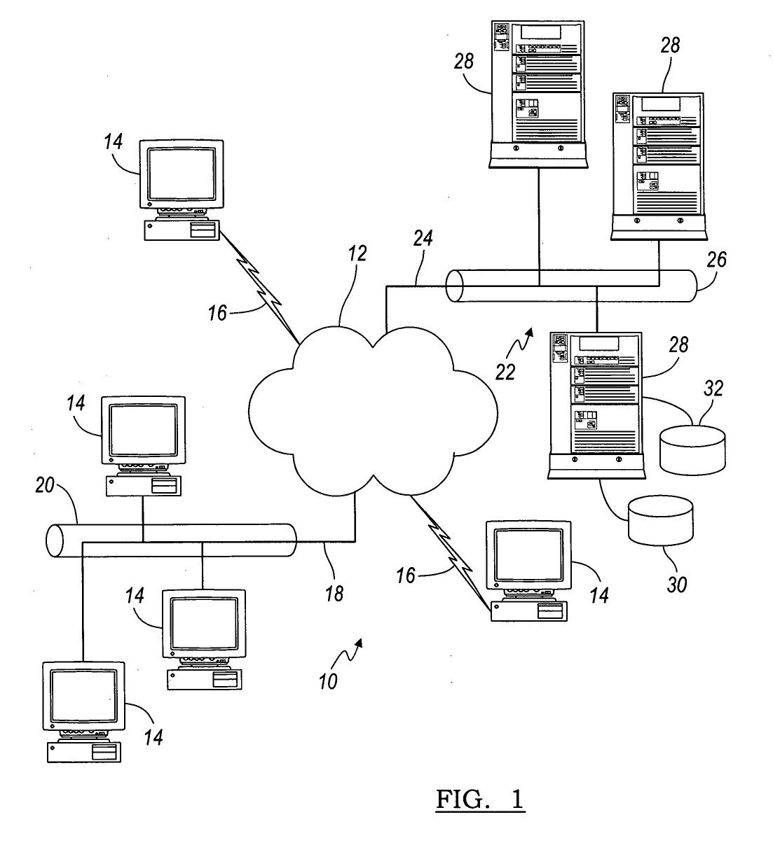

Referring now to FIG. 1, a system 10 for conducting an incentive program to facilitate the purchase of items from a merchandiser over a computer network 12 is illustrated in accordance with an embodiment of the present invention. Computer networks of many different configurations may be utilized to enable the incentive program herein described. Generally, a customer computer 14 is connected through a computer network 12 to a host or merchant computer system 22 to purchase items and participate in the incentive program, as will be described in greater detail below.

For example, the computer network 12 may be implemented over a wide area network (WAN), such as the Internet. Customer computers 14 may be any electronic device such as stationary or desktop computer, laptop or notebook computer and handheld devices such as personal data assistants (PDA's) or cell phones, and/or any other device capable of connecting to the Internet, or to a computer network that is connected to the Internet. Such electronic devices may be connected to the computer network 12 through wireless media 16 or landlines 18. Customer computers 14 may be directly connected to computer network 12 or may be connected to a local area network 20 such as an Ethernet that is connected to the Internet. The merchant or host computer system 22 may also be connected by a landline 24 and/or through a wireless connection (not shown). The merchant computer system 22 may further include a local area network 26 that interconnects the server computers 28. One or all of server computers 28 may host a merchant website for conducting product sales and merchandising over network 12. Customer computers 14 are configured to receive and transmit data to the server computers 28.

In an embodiment of the present invention, server computers 28 include program code, including but not limited to, databases 30 for storing product information for products that are on sale on the merchant's website. For example, the database may include the product's name the product customer price, the description of the product, pictures of the product, the amount of incentive credits that may be awarded, if any, and other information. An incentive program database 32 is also provided for storing information regarding products or items that may be purchased through the incentives program. The information stored in database 32 would include, for example, cost of the item, description of the item, images of the item, the maximum number of incentive credits that may be redeemed toward the purchase and other information. Of course, the present invention contemplates the use of one or more databases to store merchandise or product information related to products for sale on the merchant website including products that offer different amounts of incentive credits, if purchased.

In an embodiment of the present invention, computer code or program code is stored on merchant computer system 22 and executed by the processor thereof to implement the merchandise purchase incentive program. The merchandise purchase incentive program of the present invention is configured to provide an incentive to a customer to purchase merchandise from the merchant through merchant computer system 22. Generally, the incentive program offers a purchaser of merchandise an opportunity to earn an incentive credit or incentive dollar for a predetermined number of actual dollars spent on purchases through the merchant computer system 22. The term “actual dollars” is used herein to refer to currency, which may take many forms, i.e. U.S. dollars as well as the currency of other countries. Moreover, the use of credit or any other monetary instrument to purchase products is contemplated by the present invention as a means for payment in lieu of actual dollars.

For example, the incentive program of the present invention may award one incentive dollar or credit for each actual dollar spent on certain purchases made through merchant computer system 22. Of course, the present invention contemplates the use of other ratios of incentive dollars to actual dollars to provide a customer with an incentive to purchase certain merchandise. The credits or incentive dollars may be redeemed by the customer through the purchase of certain merchandise from the merchant's website. For example, the customer may combine the incentive dollars with actual dollars to purchase certain merchandise through the merchant computer system 22. Furthermore, the merchant may provide more of an incentive to purchase certain products than other products by awarding a higher amount of incentive credits for certain purchases. For instance, depending on the merchant's costs to produce, current inventory, and other factors the merchant may offer a varying amount of incentive credits or no incentive credits at all for the purchase of specific products.

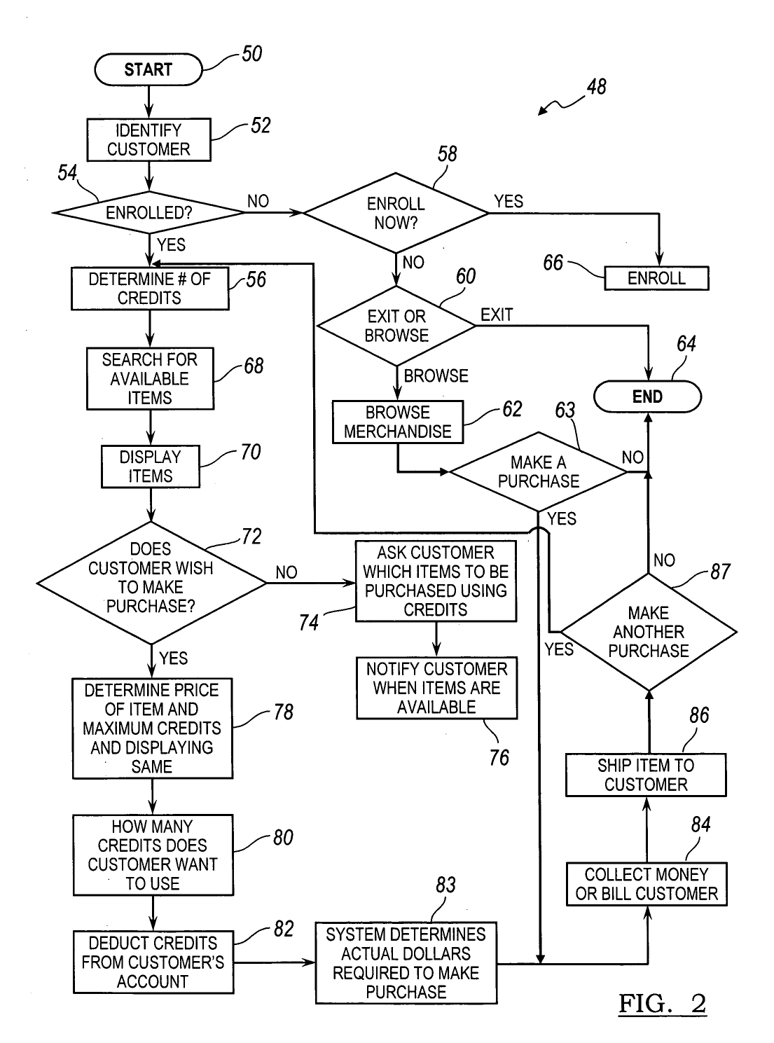

Referring now to FIG. 2, a method 48 for providing an incentive to a consumer to purchase certain products over a computer network is illustrated, in accordance with an embodiment of the present invention. The method is initiated at block 50 when a potential customer accesses a merchandising program on the merchant computer system 22. The merchandising program may be in the form of a merchant website or homepage or other suitable customer interface. The system 22 identifies the customer by either requesting that the customer enter a user ID and/or password or by accessing and reading cookies stored on the customer's computer, as represented by block 52.

After the customer has been identified, system 22 determines whether the customer is enrolled in the incentive program, as represented by block 54. If the customer is enrolled in the incentive program, at block 56, the amount of credits or incentive dollars in the customer's account is determined. If the customer is not enrolled in the incentive program then the customer is asked, at block 58, whether he wishes to enroll now. If the customer does not wish to enroll in the incentive program then, at block 60, the customer is asked if he wants to exit the system or browse the merchandise available for sale and make a purchase, as represented by blocks 62, 63 and 64. However, if the customer wishes to enroll now then the system enrolls the customer in the incentive program by recording pertinent customer information and creating an incentive program account in which credits or incentive dollars are stored, as represented by block 66. After the customer has been enrolled he may either exit the system or browse the merchandise.

If at block 54, it is determined that the customer is enrolled in the incentive program and has credits or incentive dollars in their account, a search of all items that may be purchased with credits or incentive dollars is made, as represented block 68. At block 70, the system displays the items available for purchase using credits or incentive dollars from the user's account. At block 72, the customer is asked whether they wish to purchase one of the items listed. If the customer does not wish to purchase any of the items listed then, at block 74, the customer is asked whether he would like to purchase items that are not listed using credits or incentive dollars and requests the customer to identify those items. The system notifies the customer when the desired items, if any, are available to be purchased through the incentive program, as represented by block 76.

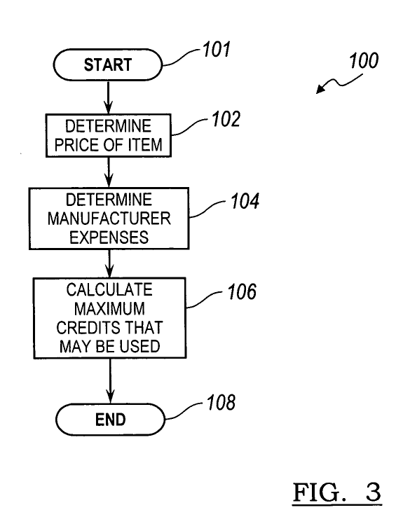

However, if the customer wishes to use his credit or incentive dollars to make a purchase from the list of items, then at block 78 the system determines the customer price of the item including the amount of actual dollars and the maximum amount of credits or incentive dollars needed to purchase the item. The calculation for determining the minimum amount of actual dollars needed to purchase an item and the maximum number of credits that may be redeemed is further described below with reference to FIG. 3. Further, at block 78 the system displays the customer price of the item and the maximum number of credits that may be redeemed toward the purchase of the item. At block 80, the system asks the customer how many credits or incentive dollars they would like to redeem towards the purchase of the selected item. At block 82 the system deducts the number of credits or incentive dollars the customer has indicated from the customer's account. At block 83, the system determines the amount of actual dollars needed to make the purchase by subtracting the number of credits or incentive dollars the customer wishes to use from the customer price of the item. As described below with reference to FIG. 3, the amount of actual dollars required to make a purchase may not be less than the determined minimum amount. At block 84, the system collects the actual dollars required to make the purchase or bills the customer that amount. At block 86, the item is shipped to the customer. At block 87, the system determines whether the customer wishes to exit the system or make another purchase.

Referring now to FIG. 3, a method 100 for determining the maximum amount of credits or incentive dollars that may be used to purchase an item is illustrated in flow chart form, in accordance with an embodiment of the present invention. The method is initiated at block 101. At block 102, the customer price of an item is determined. The customer price may be any monetary amount selected by the merchant, i.e. the suggested retail price. At block 104 the cost of materials, the labor and any other expense incurred through the manufacture of the item is determined. At block 106, the maximum amount of credits or incentive dollars that may be redeemed toward the purchase of an item is determined by subtracting the expenses of manufacturing and/or stocking/providing the item, as determined at block 104, from the customer price selected by the merchant at block 102. The method concludes at block 108 and returns to block 78 of FIG. 2. This calculation of the maximum amount of credits or incentive dollars that may be redeemed toward the purchase of an item ensures that the merchant receives at least their cost of offering the item for sale from the customer. The merchant's cost may include manufacturing expenses or merely the wholesale cost, and may further include costs related to stocking the item, staffing a warehouse, and other operating expenses which all must be incurred to make the item available for sale to the user. Thus, the customer will pay at a minimum the actual dollars equal to the merchant's cost of offering the item for sale.

The present invention has many advantages and benefits over prior art merchandising incentive programs. For example, the present invention ensures that the merchant recovers at a minimum its cost for manufacturing the merchandise while still providing an incentive to a customer to purchase products. Further, the merchant has the flexibility of changing the ratio of credits awarded to actual dollars spent by the customer. Thus, the merchant can provide varying levels of incentives to its customers to facilitate the purchase of selected merchandise.

It is therefore intended that the foregoing detailed description be regarded as illustrative rather than limiting, and that it be understood that it is the following claims, including all equivalents, that are intended to define the spirit and scope of this invention.

We claim:

1. A system for providing an incentive to purchase merchandise from a merchant over a computer network, the system comprising:
a merchant computer in communication with a customer computer over the computer network, wherein the merchant computer includes a processor coupled to a memory area;
a first control logic stored in the memory area and executable by the processor of the merchant computer for receiving a customer identifier from a customer;
a second control logic stored in the memory area and executable by the processor of the merchant computer for determining an amount of incentive program credits that are available for redemption by the customer using the customer identifier;
a third control logic stored in the memory area and executable by the processor of the merchant computer for determining a customer price of a first item that may be purchased using the incentive program credits;
a fourth control logic stored in the memory area and executable by the processor of the merchant computer for determining a cost to the merchant of the first item that may be purchased using the incentive program credits;
a fifth control logic stored in the memory area and executable by the processor of the merchant computer for determining a maximum amount of incentive program credits that may be redeemed toward the purchase of the first item by subtracting the cost to the merchant of the first item from the customer price of the item and a minimum monetary cost to the customer by subtracting the maximum amount of incentive program credits from the customer price of the first item;
a sixth control logic stored in the memory area and executable by the processor of the merchant computer for communicating the minimum monetary cost of the first item to the customer; and
a seventh control logic stored in the memory area and executable by the processor of the merchant computer for communicating the maximum amount of incentive program credits that may be redeemed toward the purchase the first item.

2. The system of claim 1 further comprising an eighth control logic stored in the memory area and executable by the processor of the merchant computer for predefining a select plurality of items that are available for purchase using the incentive program credits.

3. The system of claim 1 further comprising an eighth control logic stored in the memory area and executable by the processor of the merchant computer to provide the customer with a search engine to search for a plurality of items available for purchase using the incentive program credits.

4. The system of claim 1 wherein the first control logic stored in the memory area and executable by the processor of the merchant computer further includes receiving a password as the customer identifier.

5. The system of claim 1 further comprising an eighth control logic stored in the memory area and executable by the processor of the merchant computer for subtracting the number of credits redeemed toward the purchase of the first item from a customer's account used for storing incentive program credits.

6. The system of claim 1 further comprising an eighth control logic stored in the memory area and executable by the processor of the merchant computer for requesting the customer to identify which of a second item the customer would like to purchase by redeeming incentive program credits.

7. The system of claim 6 further comprising a ninth control logic stored in the memory area and executable by the processor of the merchant computer for notifying the customer that the second item the customer would like to purchase by redeeming incentive program credits is available for purchase.

8. The system of claim 1 wherein the fifth control logic stored in the memory area and executable by the processor of the merchant computer further includes determining the cost of the first item by determining the expenses incurred by the merchant to manufacturer the first item.

9. The system of claim 1 further comprising an eighth control logic stored in the memory area and executable by the processor of the merchant computer for issuing credits to the customer when the customer purchases a third item from the merchant.

10. The system of claim 9 wherein the ninth control logic stored in the memory area and executable by the processor of the merchant computer for issuing credits to the customer further comprises issuing one program incentive credit for every actual dollar spent by purchasing the third item.

11. A system for providing an incentive to purchase merchandise from a merchant over a computer network, the system comprising:
a merchant computer coupled with a customer computer through the computer network, wherein the merchant computer has a memory area that is searchable for determining a first merchandise available for purchase; and
an executable program code stored in the memory area of the merchant computer for creating an incentive program to facilitate the purchase of a second merchandise by the customer from the merchant by issuing incentive program credits for the purchase of the first merchandise wherein the program credits are redeemable toward the purchase of the second merchandise, determining a customer price of the second merchandise, determining an expense incurred by the merchant to obtain the second merchandise, determining a maximum incentive program credits that the customer may redeem toward the purchase of the second merchandise by subtracting the expense incurred by the merchant to obtain the second merchandise from the customer price of the second merchandise, and communicating to the customer the maximum incentive program credits that the customer may redeem toward the purchase of the second merchandise.

12. The system of claim 11 wherein the executable program code further comprises program code for predefining a plurality of second merchandise that are available for purchase using the incentive program credits.

13. The system of claim 12 wherein the executable program code further comprises program code to provide the customer with a search engine to search for the second merchandise available for purchase using the incentive program credits.

14. The system of claim 11 wherein the executable program code further comprises program code for subtracting the number of credits redeemed toward the purchase of the second merchandise from a customer's account used for storing incentive program credits.

15. The system of claim 11 wherein the executable program code further comprises program code for requesting the customer to identify which of a third merchandise the customer would like to purchase by redeeming incentive program credits.

16. The system of claim 15 wherein the executable program code further comprises program code for notifying the customer that the third merchandise the customer would like to purchase by redeeming incentive program credits is available for purchase.

17. The system of claim 11 wherein the executable program code further comprises program code for determining the cost of the second merchandise by determining the expenses incurred by the merchant to manufacturer the second merchandise.

18. The system of claim 11 wherein the executable program code further comprises program code for issuing credits to the customer when the customer purchases the first merchandise from the merchant.

19. The system of claim 18 wherein the executable program code further comprises program code for issuing one program incentive credit for every actual dollar spent by purchasing the first merchandise.

20. A method for providing an incentive to purchase merchandise from a merchant over a computer network, wherein a merchant computer is in communication with a customer computer over the computer network, and wherein the merchant computer includes a processor coupled to a memory area, the method comprising:
determining an amount of incentive program credits that are available for redemption by the customer;
determining a customer price of a first item that may be purchased using the incentive program credits;
determining a cost to the merchant of the first item that may be purchased using the incentive program credits;
determining a maximum amount of incentive program credits that may be redeemed toward the purchase of the first item by subtracting the cost to the merchant of the first item from the customer price of the first item;
communicating the minimum monetary cost of the first item to the customer, wherein the minimum monetary cost is the customer price of the first item minus the maximum amount of incentive program credits that may be redeemed toward the purchase of the first item; and
communicating the maximum amount of incentive program credits that may be redeemed toward the purchase the first item.

21. The method of claim 20 further comprising predefining a select plurality of items that are available for purchase using the incentive program credits.

22. The method of claim 20 further comprising providing the customer with a search engine to search for a plurality of items available for purchase using the incentive program credits.

23. The method of claim 20 further comprising subtracting the number of credits redeemed toward the purchase of the first item from a customer's account used for storing incentive program credits.

24. The method of claim 20 further comprising requesting the customer to identify which of a second item the customer would like to purchase by redeeming incentive program credits.

25. The method of claim 24 further comprising notifying the customer that the second item the customer would like to purchase by redeeming incentive program credits is available for purchase.

26. The method of claim 20 further comprising determining the cost of the first item by determining the expenses incurred by the merchant to manufacturer the first item.

27. The method of claim 20 further comprising issuing credits to the customer when the customer purchases a third item from the merchant.

28. The method of claim 27 wherein issuing credits to the customer further comprises issuing one program incentive credit for every actual dollar spent by purchasing the third item.

29. A system for providing an incentive to purchase merchandise from a merchant over a computer network, the system comprising:
a merchant computer coupled with a customer computer through the computer network, wherein the merchant computer has a memory area that is searchable for determining a first merchandise available for purchase; and
a means for creating an incentive program to facilitate the purchase of a second merchandise by the customer from the merchant by issuing incentive program credits for redemption toward the purchase of the second merchandise, determining a customer price of the second merchandise, determining an expense incurred by the merchant to obtain the second merchandise, determining a maximum incentive program credits that the customer may redeem toward the purchase of the second merchandise by subtracting the expense incurred by the merchant to obtain the second merchandise from the customer price of the second merchandise, and communicating to the customer the maximum incentive program credits that the customer may redeem toward the purchase of the second merchandise.
